(19) United States
(12) Patent Application Publication
(10) Pub. No.: US 2017/0328214 A1
(43) Pub. Date: Nov. 16, 2017

(54) TURBINE BLADE

(71) Applicant: ANSALDO ENERGIA S.p.A, Genova (IT)

(72) Inventor: Vittorio ODEMONDO, GENOVA (IT)

(73) Assignee: ANSALDO ENERGIA S.p.A, Genova (IT)

(21) Appl. No.: 15/524,089

(22) PCT Filed: Nov. 6, 2015
(86) PCT No.: PCT/IB2015/058594

§ 371 Date: May 3, 2017

(30) Foreign Application Priority Data
Nov. 7, 2014 (IT) MI2014A001927

(51) Int. Cl. F01D 5/18

(52) U.S. Cl. CPC F01D 5/186; F05D 2260/202; F05D 2250/52; F05D 2220/32; F05D 2240/301; F05D 2250/291

(57) ABSTRACT

A turbine blade is provided with at least one cooling channel and a plurality of cooling holes; each cooling hole being provided with an outlet section having an elongated shape along a principal axis; the height of the outlet section, intended as the measure of the maximum dimension of the outlet section along a direction parallel to the main axis, being equal to at least twice the width of the outlet section, intended as the maximum dimension of the outlet section along a direction orthogonal to the main axis.

### TECHNICAL FIELD

The present invention relates to a turbine blade.

In particular, the present invention relates to a blade of a gas turbine in an electrical energy production plant.

### BACKGROUND ART

During the operation of the electrical energy production plants, the blades of gas turbines are constantly exposed to a hot gas flow coming from the combustion chamber.

The temperature of the hot gas flowing in the gas turbine affects the performance of the plant. In particular, the performance of the plant increases with an increasing temperature of the gas flowing inside the turbine.

However, the increase of the temperature of the gas flowing in the gas turbine is limited by the thermal resistance of the material constituting the blades.

To overcome this kind of limitation, in recent years it has been adopted a cooling system comprising a plurality of holes, which are distributed along the blade and are fed with cooling air. The holes are shaped and fed so as to generate a sort of protective film along the surface of the blade. This technique is usually called “film cooling” and determines an increase of the thermal resistance of the turbine blades. In this way, the temperature of the hot gas can be higher than the temperatures eligible for blades lacking the cooling system.

In any case, the cooling systems of known type allow a limited temperature increase.

### DISCLOSURE OF INVENTION

It is therefore an object of the present invention to provide a blade having an optimized cooling system, capable of improving the thermal resistance of the blades and allowing a further increase of the temperature of the gases flowing in the gas turbine, thus consequently improving the plant performance.

According to this object, the present invention relates to a turbine blade comprising at least one cooling channel and a plurality of cooling holes; each cooling hole being provided with an outlet section having an elongated shape along a main axis; the height of the outlet section, intended as the measure of the maximum dimension of the outlet section along a direction parallel to the main axis, being equal to at least twice the width of the outlet section, intended as the maximum dimension of the outlet section along a direction orthogonal to the main axis.

Thanks to the fact that the cooling holes have an outlet section having an elongated shape, the distribution of the cooling fluid film occurs over an area wider than that obtainable with the blade holes of the prior art.

It is a further object of the invention to provide a high-performance, electrical energy production plant, allowing the use of gas at temperatures higher than those used so far.

In accordance with these objects, the present invention relates to an electrical energy production plant comprising the blade in accordance with any one of claims 1 to 22.

### BRIEF DESCRIPTION OF THE DRAWINGS

Further characteristics and advantages of the present invention will become clear from the following description of a non-limiting exemplary embodiment, with reference to the figures of the accompanying drawings, in which:

FIG. 1 is a schematic view of a gas turbine plant for the production of energy;

FIG. 2 is a perspective view, with parts in section and parts removed for clarity's sake, of a portion of a blade according to the present invention;

FIG. 3 is a sectional view, with parts in section and parts removed for clarity's sake, of a first detail of the blade of FIG. 2;

FIG. 4 is a perspective view, with parts in section and parts removed for clarity's sake, of a second detail of the blade of FIG. 2;

FIG. 5 is a side view, with parts removed for clarity's sake, of a third detail of the blade of FIG. 2.

### BEST MODE FOR CARRYING OUT THE INVENTION

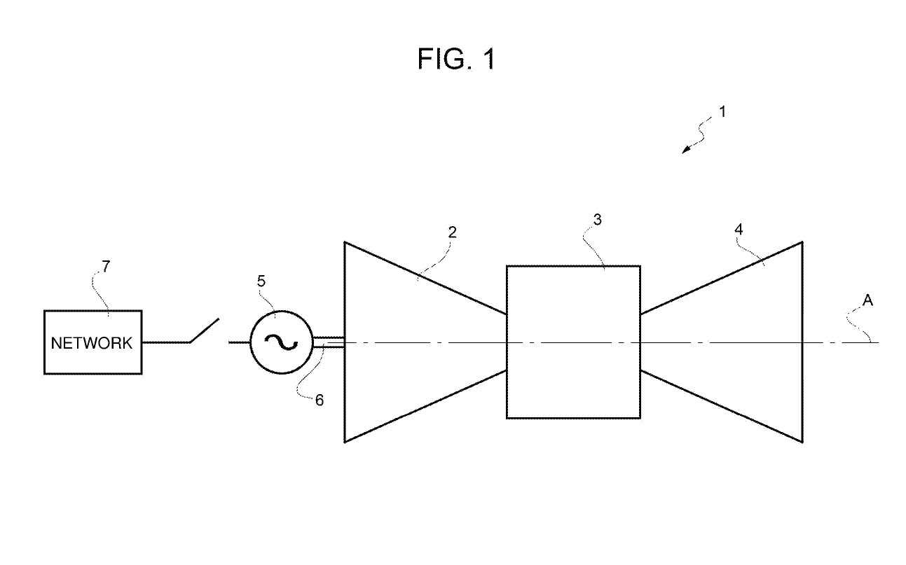

FIG. 1 indicates a portion of an electrical energy production plant with the reference number 1.

The electrical energy production plant 1 is of known type and comprises a compressor 2, within which an air flow flows, a combustion chamber 3 supplied with fuel and air from the compressor 2, a gas turbine 4 within which the gases coming from the combustion chamber 3 flow, and a generator 5, mechanically connected to a same shaft 6 of the gas turbine 4 and of the compressor 2 and coupled to an electricity distribution network 7.

The compressor 2 and the gas turbine 4 extend along a longitudinal axis A and respectively define a compression channel and an expansion channel along which radial arrays of rotor blades (not shown in FIG. 1) revolving around the axis A and radial rows of stator blades (not shown in FIG. 1) alternate.

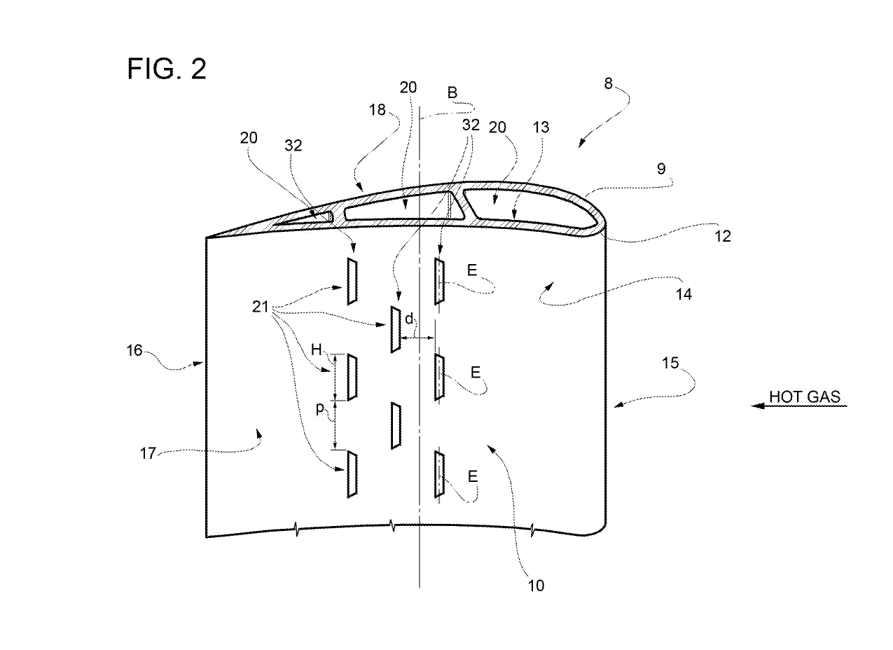

FIG. 2 partially shows a blade 8 arranged along the expansion channel of the gas turbine 4.

Preferably, the blade 8 is a rotor blade. It is clear that the present invention can also be applied to stator blades. The blade 8 comprises an elongate main body 9 (partially shown in FIG. 2), which extends along a respective extension axis B radially with respect to the axis A, a first anchoring portion (not shown in FIG. 2) coupled, in use, to a respective rotor disc of the gas turbine 4, and a cooling device 10 (partially shown in FIG. 2).

The main body 9 is preferably hollow and comprises a wall 12 provided with an inner face 13 and an outer face 14.

The wall 12 is shaped so as to define along the outer surface 14 an inlet edge 15, commonly called “leading edge”, an outlet edge 16, commonly called “trailing edge”, a concave face 17 called belly (commonly called “pressure side”) and a convex face 18 called back (commonly called “suction side”).

The cooling device 10 comprises a plurality of cooling channels 20 (only some of which are visible in FIG. 2) and a plurality of cooling holes 21 made in the wall 12 of the blade 8.

The cooling channels 20 extend inside the main body 9 and are fed with a cooling fluid. Preferably, the cooling fluid is air tapped from the compression channel of the compressor 2.

The cooling holes 21 are preferably made in the wall 12 along the pressure side 17 of the blade 8.

According to a variant, the cooling holes 21 are also made along the suction side 18 and/or close to the leading edge 15 of the blade 8 and/or close to the trailing edge 16 of the blade 8.

According to a further variant, the cooling holes are also made along the anchoring portion of the blade 8, preferably along the platform of the blade in contact with the elongated main body 9.

Preferably, the cooling holes 21 are substantially identical to each other. Therefore, for the sake of simplicity, the characteristics and the shape of only one of the cooling holes 21 will be described hereinafter.

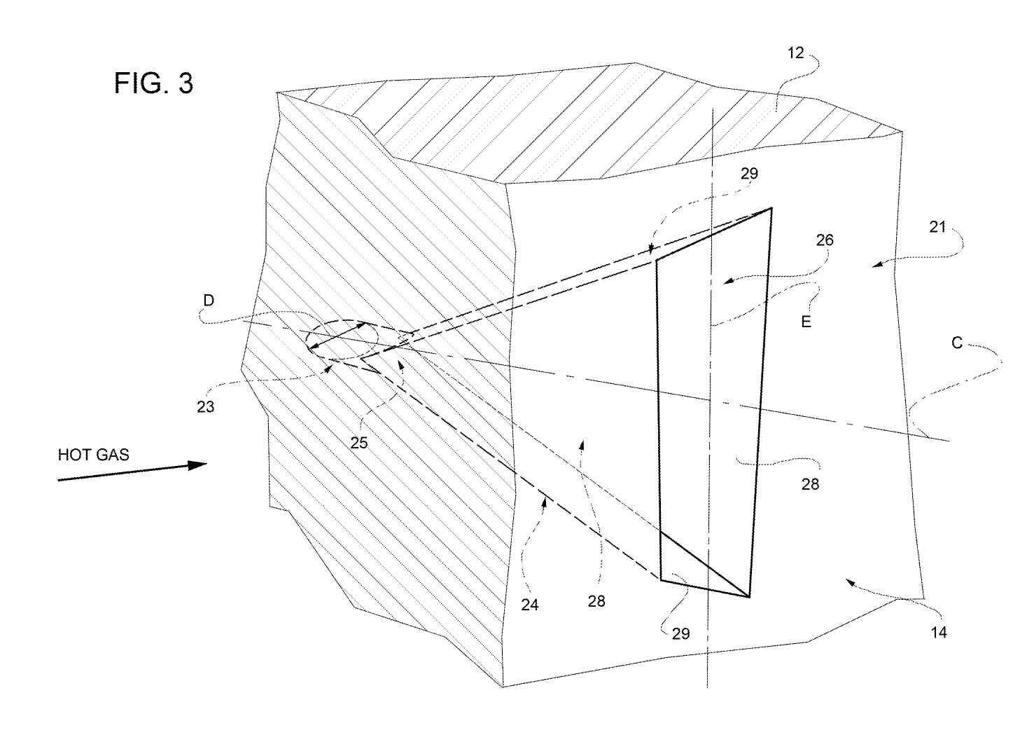

With reference to FIG. 3, each cooling hole 21 passes through the wall 12 of the main body 9 and comprises an inlet portion 23 and an outlet portion 24.

The inlet portion 23 is in communication with a respective cooling channel 20 (FIG. 2) and is defined by a conduit of constant section, which extends along an extension axis C.

The section of the inlet portion 23 affects the flow rate of the cooling fluid from the cooling channel 20 which can be fed through the cooling hole 21.

The larger the section of the inlet portion 23, the larger the flow rate of cooling fluid through the cooling hole 21. The conduit of the inlet portion 23 has a maximum dimension D measured transverse to the extension axis C. In the non-limiting example here described and illustrated, the conduit of the inlet portion 23 has a circular cross section and the maximum dimension D coincides with the diameter of the conduit.

In the non-limiting example here described and illustrated, the diameter D of the conduit of the inlet portion is comprised between 0.40 mm and 0.80 mm.

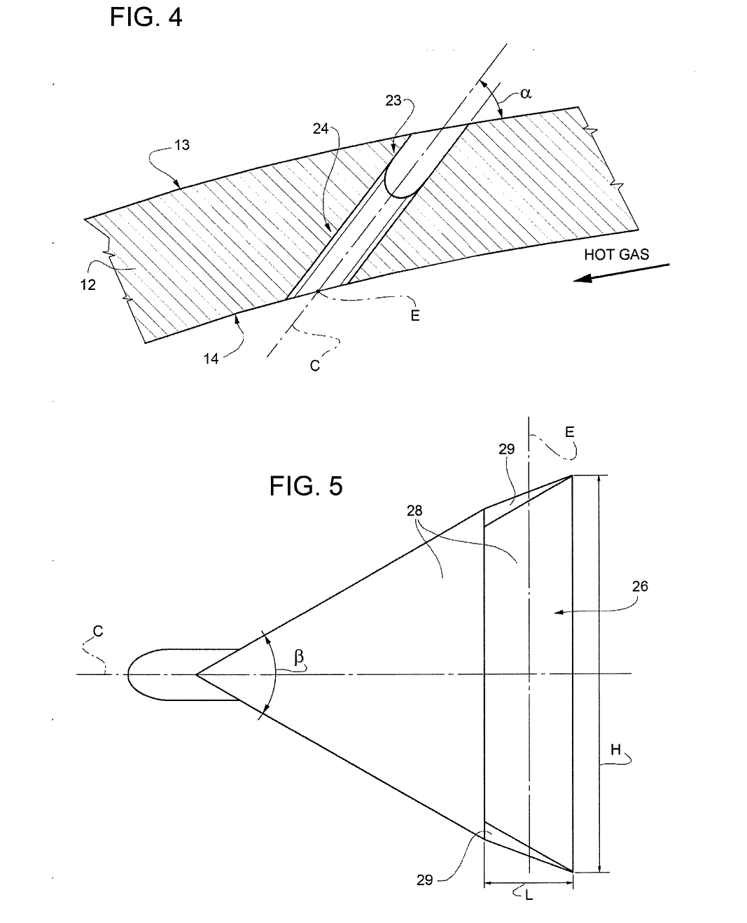

With reference to FIG. 3 and FIG. 4, the inlet portion 23 extends along an extension axis C preferably inclined at a first angle α with respect to the inner face 13 of the wall 12.

The angle α is comprised between 10° and 50°, for example between 30° and 50°, for example between 30° and 40°.

In the non-limiting example here described and illustrated, the angle α is equal to 36°.

The outlet portion 24 is connected to the inlet portion 23 and is defined by a conduit having a section gradually increasing towards the outer face 14 of the wall 12.

Preferably, the outlet portion 24 maintains the same inclination of the inlet portion 23 and extends along the extension axis C as shown in FIG. 4.

According to a variant not shown, the outlet portion 24 is inclined with respect to the inlet portion 23 at an angle comprised between 0° and 5°.

With reference to FIG. 3, the outlet portion 24 has an inlet section 25 in communication with the inlet portion 23 and an outlet section 26 which is formed along the outer face 14 of the wall 12.

The inlet section 25 has a preferably circular or quadrilateral shape, while the outlet section 26 is preferably quadrilateral.

Preferably, the outlet section 26 is centred on the extension axis C.

With reference to FIGS. 2 and 5, the outlet section 26 has an elongated shape along a main axis E and is characterized by a maximum height H, intended as the measure of the maximum dimension of the outlet section 26 along a direction parallel to the main axis E, and a width L, intended as the maximum dimension of the outlet section 26 in the direction orthogonal to the main axis E.

Preferably, the height H is equal to at least twice the width L.

According to a variant, the height H is equal to at least 3 times the width L.

According to a further variant, the height H is equal to at least 4 times the width L.

In the non-limiting example here described and illustrated, the height H is greater than 4 times the width L.

In the non-limiting example here described and illustrated, the main axis E is substantially parallel to the axis B of the blade 8.

With reference to FIGS. 3 and 5, the outlet portion 24 is defined by two base walls 28 preferably parallel to each other and by two side walls 29, which diverge from each other towards the outlet section 26 so as to define a conduit having a section increasing towards the outlet section 26.

With reference to FIG. 5, the side walls 29 are divergent and define an angle β between them.

Preferably, the angle β is comprised between 35° and 60°, for example between 40° and 60°.

In the non-limiting example here described and illustrated, the angle β is approximately 50°.

According to a variant not shown, the angle β is about 40°. Preferably, the side walls 29 are symmetrical with respect to a symmetry axis.

In the non-limiting example here described and illustrated, the symmetry axis coincides with the extension axis C.

The side walls 29 are preferably orthogonal to the base walls 28.

Preferably, the edges between the side walls 29 and the base walls 28 are rounded so as to improve the structural stability.

According to a variant not shown, the side walls 29 are inclined with respect to the walls of the base 28, for example so as to define a conduit having an increasing cross-section of trapezoidal shape.

The base walls 28 and the side walls 29 extend from the inlet section 25 to the outlet section 26.

With reference to FIG. 2, the cooling holes 21 are staggered along the pressure side 17 so as to ensure a homogeneous cooling of the portion of the blade 8 they are facing.

In particular, the cooling holes 21 are distributed in a plurality of rows 32 of aligned holes.

The rows 32 are preferably parallel to each other and arranged along directions parallel to the main axis E.

In the example here described and illustrated, wherein the main axis E is parallel to the axis B, the rows 32 are arranged along respective directions parallel to the axis B.

According to a variant not shown, the main axis E is transverse to the axis B and, consequently, the rows 32 are arranged along respective directions transverse to the axis B.

The cooling holes 21 of each row 32 are arranged at a distance p from each other, measured along a direction parallel to the axis B.

The distance p between the cooling holes 21 of a row 32 is preferably at least equal to the projection along the axis B of the height H of the cooling holes 21 of the adjacent row 32.

The rows 32 are arranged at a distance d from one another, preferably having a value comprised between 10 times and 30 times the diameter D of the inlet portion 23.

As already stated, the cooling holes 21 of a row 32 are staggered with respect to the cooling holes 21 of the adjacent row 32. Preferably, the staggering between the holes is such that the centre of at least one cooling hole of the row 32 is substantially arranged at half the distance p between the corresponding cooling holes 21 of the adjacent row 32.

In this way, the particular arrangement of cooling holes 21 ensures that the cooling fluid substantially laps the entire surface of the pressure side 17 of the blade 8 provided with the cooling holes 21.

The efficiency η of the cooling device 10 of the blade 8 according to the present invention is higher than that obtainable with the blade cooling devices of known type.

To this regard, efficiency η means:

η=(T_{hot gas}−T_{wall})(T_{hot gas}−T_{cooling fl})

wherein:
T_{hot gas}=is the temperature of the gas flowing in the gas turbine 4;
T_{wall}=is the temperature of the wall 12 of the blade 8;
T_{cooling fl}=is the temperature of the cooling fluid detected inside the blade 8.

Thanks to the particular geometry and arrangement of the cooling holes 21, the efficiency η of the cooling device 10 of the blade 8 according to the present invention is higher than that obtainable for a blade of known type with an equal flow of cooling fluid.

The particular shape and arrangement of the cooling holes 21, in fact, lowers the T_{wall} with respect to that obtainable with cooling holes having a standard shape and arrangement. This allows for proper thermal protection of the blade 8 also when the operating regime of the gas turbine 4 causes a rise in temperature of the hot gas T_{hot gas}.

The geometry and arrangement of the holes according to the present invention, therefore, allows an increase of the temperature of the hot gas T_{hot gas} circulating in the gas turbine 4 and/or a reduction in the required flow rate of cooling fluid, normally taken from the compressor 2.

The decrease of the cooling fluid rate and the increase of the temperature T_{hot gas} of the hot gas circulating in the gas turbine 4 determine an increase in the overall efficiency of the plant 1.

In the specific non-limiting example of the holes here described and illustrated, the shape and the arrangement of the cooling holes 21 entails a clear improvement of the efficiency value η and a simultaneous reduction of consumed cooling fluid with respect to the holes of standard blades. Finally, the particular arrangement of the cooling holes 21 of the blade 8 according to the present invention determines a substantially complete coverage of the surface of the wall 12 exposed to the hot gas flow. In fact, the cooling holes 21 are arranged so that the flow of cooling air flowing out of a cooling hole 21 of a row 32 completely covers the space between the two cooling holes 21 of the adjacent row 32.

Moreover, the particular arrangement of the cooling holes of the blade 8 is particularly advantageous if the cooling holes 21 are characterized by a height H equal to at least twice the width L; otherwise the described particular arrangement of the holes would result in an excessive reduction of the distance between the cooling holes and in a sharp increase in the number of holes, with a consequent increase in the consumed cooling fluid and in a degradation of the structural properties of the blade. Finally, the particular geometry and arrangement of the cooling holes 21 of the blade 8 according to the present invention does not require special machining processes with respect to machining processes employed for the production of the holes according to the prior art.

Finally, it is evident that the described blade and plant may be modified and varied without departing from the scope of the appended claims.

1-23. (canceled)

24. Turbine blade comprising at least one cooling channel, a plurality of cooling holes and a hollow main body extending along a longitudinal axis and provided with a wall having an outer face and an inner face; the cooling channel extending inside the main body; each cooling hole being provided with an outlet section having an elongated shape along the main axis; the height of the outlet section, intended as the measure of the maximum dimension of the outlet section along a direction parallel to the main axis, being equal to at least twice the width of the outlet section, intended as the measure of the maximum dimension of the outlet section along a direction orthogonal to the main axis; the turbine blade being characterized in that:
each cooling hole comprises an inlet portion in communication with the respective cooling channel and an outlet portion comprising the outlet section; wherein the inlet portion comprises a conduit having a constant section and extending along an extension axis;
the extension axis is preferably inclined at a first angle with respect to the inner face of the wall; the first angle is comprised between 10° and 50°;
the outlet portion is inclined with respect to the inlet portion at a second angle comprised between 0° and 5°,
the outlet portion comprises two base walls parallel to each other and two side walls diverging towards the outer face; wherein the side walls form a third angle; wherein the third angle is comprised between 35° and 60°.

25. Blade according to claim 24, wherein the cooling holes are made in the wall and are in communication with the cooling channel.

26. Blade according to claim 24, wherein the outlet section is quadrilateral.

27. Blade according to claim 24, wherein the wall is shaped so as to define along the outer face a leading edge, a trailing edge, a pressure side and a suction side; the cooling holes being made in the wall at least along the pressure side.

28. Blade according to claim 24, wherein the main axis is parallel to the longitudinal axis of the blade.

29. Blade according to claim 24, wherein the outlet portion comprises a conduit having a section gradually increasing towards the outer face of the wall.

30. Blade according to claim 24, wherein the side walls are symmetrical with respect to a symmetry axis.

31. Blade according to claim 24, wherein the cooling holes are aligned along a plurality of rows.

32. Blade according to claim 31, wherein the rows are arranged along respective directions parallel to the main axis.

33. Blade according to claim 31, wherein the cooling holes of each row are arranged at a first distance one from the other measured along a direction parallel to the axis.

34. Blade according to claim 33, wherein the first distance between the cooling holes of one row is at least equal to the projection along the longitudinal axis of the height of the cooling holes of the adjacent row.

35. Blade according to claim 31, wherein the cooling holes of a row are staggered with respect to the cooling holes of the adjacent row.

36. Blade according to claim 35, wherein the cooling holes of a row are staggered with respect to the cooling holes of the adjacent row so that the centre of at least one cooling hole of the row is arranged substantially at the middle of the first distance between the respective cooling holes of the adjacent row.

37. Blade according to claim 31, wherein each cooling hole comprises an inlet portion, which is in communication with the respective cooling channel and comprises a conduit having a constant section and extending along an extension axis; the rows being arranged at a second distance one from the other, whose value is comprised between ten times and thirty times the maximum dimension of the conduit of the inlet portion measured transversally to the extension axis.

38. Power plant for the production of electrical energy comprising at least one turbine provided with at least one blade according to claim 24.
